(19) United States
(12) Patent Application Publication
(10) Pub. No.: US 2004/0268249 A1
(43) Pub. Date: Dec. 30, 2004

(54) Document transformation

(76) Inventors: Thomas Fennelly, Laois (IE); Ronan Charles Brady, Dublin (IE); Ronan John Geraghty, Dublin (IE); Rotan Hanrahan, Dublin (IE)

Correspondence Address: JACOBSON HOLMAN PLLC, 400 SEVENTH STREET N.W., SUITE 600, WASHINGTON, DC, 20004, US

(21) Appl. No.: 10/902,033

(22) Filed: Jul. 30, 2004

Related U.S. Application Data
(63) Continuation of application No. PCT/IE03/00017, filed on Feb. 3, 2003.

(30) Foreign Application Priority Data
Feb. 4, 2002 (IR) 2002/0074

(51) Int. Cl. G06F 17/00

(52) U.S. Cl. 715/523

(57) ABSTRACT

In a server a source document is represented as a source document object model (13). For delivery of the source document to a user device such as a mobile phone the server dynamically selects transformation maps (10) and merges them to provide a compound map (12). The maps (10) are selected according to characteristics of the delivery channel and of the user device. The source DOM (13) is then transformed into a target DOM (14) in a single pass. Each node of the source DOM (13) self-transforms using the map rules. At the node level the transformation may change node attributes and/or node-to-node relationships.

### FIELD OF THE INVENTION

This invention relates to a method and system for transforming documents for delivery to a variety of computing, display, or mobile devices in electronic form.

### PRIOR ART DISCUSSION

In many such situations, document transformation provides content to end users in an environment comprising diverse content viewing devices having widely differing characteristics. This causes considerable complexity in document transformation.

In recent years, the small set of Web browsers that are familiar to most users of personal/office computers (PCs) has been joined by a large variety of alternative content browsers that are available on a large variety of computing/display platforms, especially mobile devices. The shape, size and processing capability varies considerably among these devices. Furthermore, to cater for the different capabilities of these devices, alternative representations of content have appeared. These are usually in the form of alternative mark-up languages. Languages such as Compact. HTML, XHTML Basic and Wireless Mark-up Language form part of this collection of alternatives. There are mechanisms to transform the markup of the source content into an alternative mark-up for the viewing device. The markup for the target device often differs from the prevailing standards because of limited/additional features, or failure to implement standard features correctly. These variances make it difficult to generate broadly acceptable content for the diverse set of devices and browsers.

In the prior art, XSLTs Extensible Markup Language (XML) Style-sheet Transformation modules) have been used for transforming one form of XML content to another. However, there are shortcomings associated with the use of XSLTs. XSLT operates on the basis of transforming document object models (DOMs) in which the transformation process requires multiple passes of a DOM each involving intensive processor operations. It appears that this approach would lead to a requirement for considerable server processor resources where the server is required to transmit documents to a wide variety of different devices.

The invention is therefore directed towards providing an improved document transformation method and system.

### SUMMARY OF THE INVENTION

According to the invention, there is provided a process carried out by a server for providing an output document of content for delivery to a user device, by transforming a source document, characterised in that,

the source document is represented in the server as a source document object model (DOM) having a plurality of interconnected nodes,

the server dynamically selects a transformation map according to characteristics of the user device and/or its delivery channel, the transformation map comprising at least one transformation rule, and

the server transforms the source DOM to a target DOM on a node-by-node basis according to the selected transformation map.

In one embodiment, a source node transforms to provide a target node having different attributes.

In another embodiment, a source node transforms to provide a target node having a different node-to-node relationships.

In a further embodiment, a source node transforms to provide different attributes or relationships of a plurality of target nodes.

In one embodiment, a source node transforms to create at least one additional target node.

In another embodiment, at least one source node self-transforms by executing a node method to dynamically execute a rule of the transformation map.

In a further embodiment, there is a transformation map associated with each potential user device and delivery channel combination.

In one embodiment, a rule of the selected transformation map causes an additional rule to be retrieved, either from within the server or from an external system.

In another embodiment, a node transforms while other source document nodes are being linked to complete the source DOM.

In a further embodiment, the transformation takes place in a single pass.

In one embodiment, the transformation map is represented as a mark-up language document and associated external classes.

In another embodiment, the process comprises the step of selecting a plurality of transformation maps and merging them to provide a compound transformation map.

In a further embodiment, the transformation map includes a null rule causing a source node to be unchanged.

In one embodiment, external rules referenced by rules of the transformation map are retrieved by reference to an object class.

In another embodiment, the transformation replaces elements in a source node with content that represents a fragment of embedded script in which a tag refers to a user device-side process.

In another aspect, the invention provides a server comprising means for performing a process as described above in any embodiment.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:—

FIG. 1 is a diagram illustrating the components and steps involved in a process of transforming a document object model (DOM) according to a method of the invention; and

FIG. 2 illustrates how rules may be applied at different points.

### DESCRIPTION OF THE EMBODIMENTS

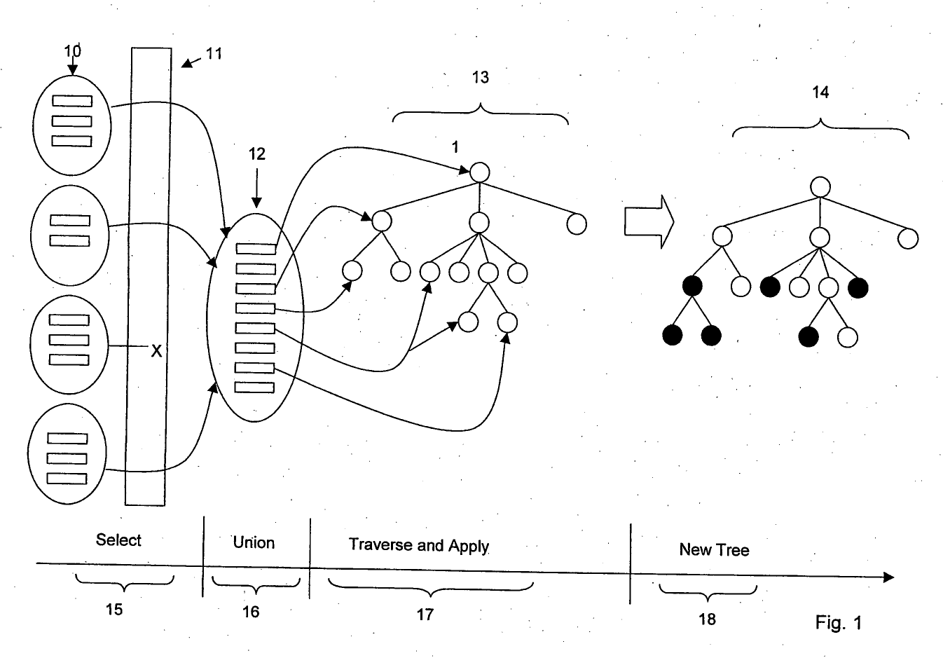

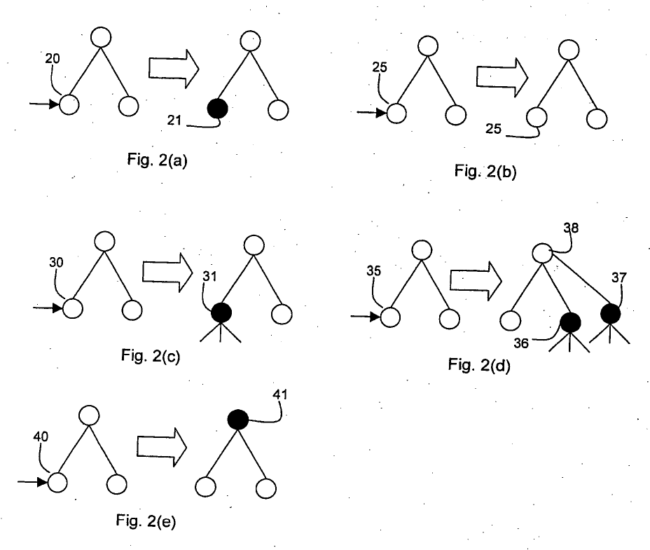

Referring to FIGS. 1 and 2, a document transformation method of the invention is illustrated. A transformation server 11 stores dynamic transformation maps (DTMs) 10 each comprising a set of rules. It constructs a single DTM 12 from the DTMs 10.

The server 11 also stores documents of content for distribution to a variety of end user devices on a variety of types of delivery channel. The documents are stored as document object models (DOMs) 13. The server 11 dynamically transforms an original DOM 13 to a new DOM 14. The DTM 12 comprises rules that are applied directly by the transformation process to the DOM 13 to transform its structure into the DOM 14 suited to the relevant delivery channel. The main method steps 15, 16, 17, and 18 are shown along the bottom of FIG. 1.

Referring to steps 15 and 16 of FIG. 1, the DTM 12 comprises a set of rules, which are selected dynamically as appropriate to the characteristics of the delivery channel. The server 11 may create a new DTM 12 through the union of several DTMs 10. Such a union is determined according to the properties of the delivery channel. The server 11 includes a selection process that uses device hardware and browser attributes and other attributes associated with the delivery channel to determine the appropriate collection of DTMs 10.

The different types of rules associated with DTMs, the construction of DTMs and their execution are described in more detail below.

FIG. 1, steps 17 and 18 illustrate the transformation of the original DOM 13 into a new DOM 14 that represents the delivered content for a specific device. FIG. 2 illustrates some basic transformation of nodes by the process of the invention.

The transformation method typically consumes the original mark-up (document) and constructs a representation of the document as a hierarchy of objects. This DOM is then manipulated to produce an alternative DOM that represents the resulting document, and this resulting document is produced from the DOM by traversing the hierarchy in-order and emitting the value of each node in the form of text and/or tags.

The rules within a DTM may be applied directly by the transformation process, and/or applied indirectly via additional software components referenced in the DTM.

The server 11, in real time, determines characteristics of a delivery channel for a document download request. It uses these characteristics to dynamically select DTMs 12 and use them to perform a pass through the DOM 13. The transformation process takes place in a single pass. In the process of traversing the DOM 13, each node is instructed to self-transform. At each step in the traversal, i.e. at each node, it is considered whether a particular rule applies. If a rule is applicable then that node is transformed accordingly and the process moves on. If no rule is applicable, then there is no need for a transformation and the process moves on to the next node. Transformations are made only where required with reference to the rules. When each node performs self-transformation this may involve changing its internal characteristics and/or its relationships to the other nodes. Transformation examples are shown diagrammatically in FIG. 2(a) to 2(e). Thus, the output DOM 14 may have a very different structure. Because of the self-transformation nature of the individual nodes the DOM 13 is sometimes referred to in this specification as an “iDOM” (Intelligent DOM).

Referring to FIG. 2(a) transformation of a node 20 involves modification to provide a node 21 with the same inter-node structure. In the example of FIG. 2(b) transformation of a node 25 provides an unchanged node in the target DOM with the same inter-node structure. In FIG. 2(c) a transformation of a source node 30 provides a target node 31 with additional dependencies. Referring to FIG. 2(d) transformation of a node 35 causes other parts of the structure to be changed. In this case two additional nodes 36 and 37 depend on the parent node 38. As shown in FIG. 2(e), transformation of a node 40 provides a modified parent node 41 in the target DOM.

These transformations are merely examples of possible scenarios. However, they illustrate the transformation versatility arising from the DTM's rules. These rules may be executable program code embedded rules, rules retrieved from local storage, or rules retrieved from remote sources. In the latter case local caching may be required for performance reasons.

The invention enhances the process of transforming a channel-neutral mark-up to a channel-specific mark-up (or format) adapted to the limits or extensions present in the target mark-up (or format). The invention provides a rules-based framework for channel-specific transformation adjustments. The framework permits extensions to the channel-neutral mark-up so that rules may be incorporated into the transformation process to enable such extensions be translated to channel-specific features.

Many devices and browsers claim to be compliant with standard mark-up languages (HTML, WML, iMode etc.) but in reality they typically omit some features, incorrectly support some features and offer additional features not found in the standards. Such devices and browsers are “close” to compliance, but are strictly non-compliant. To ensure that a document (such as a response to a request from a browser) is acceptable to a wide variety of devices and browsers one could limit the document to a subset of the standard that is correctly supported. This approach limits the expressivity of the content author and eliminates any opportunity to exploit special features of devices and browsers. On the other hand, the invention permits the author to use a highly expressive mark-up language, and then the system adjusts the mark-up according to the known features of the target device/browser.

The translation of XHTML to WML demonstrates an ability to support WML devices. In an example, some WML devices that have additional features, such as the <table> tag, which is not a feature of WML 1.1. However, some landscape-oriented WML 1.1 devices will accept this tag, presumably in anticipation of WML 1.2. Therefore, to take advantage of this feature, the translation from XHTML to WML would need to be altered so that <table> tags are preserved when delivered to WML devices that support tables. The invention achieves this due to the power and flexibility of dynamic rule-based self-transformation on a node-by-node basis.

In another example, most browsers support the heading tags of XHTML (<h1> to <h6>) as required by the standard, but some do not implement them as expected. In some cases, there is no distinction between a heading and a normal paragraph. This problem is solved by replacing the heading tags with paragraph tags and suitable text formatting according to DTM rules.

As described with reference to FIGS. 2(a) to 2(e), content transformation (or transcoding) replaces one form of content with another, typically by substituting the original mark-up with a suitable alternative. The transformation process may use one-to-one substitution and/or substitution of one structure comprised of source mark-up with an alternative structure comprised of the alternative mark-up. The transformation may be applied to the entire document structure (the DOM) or to individual parts of the structure. The transformation process may represent conceptual structures. (e.g. tables) using alternative conceptual structures (e.g. columnar text) where the alternative mark-up has no direct equivalent. When no close equivalent is available in the alternative mark-up, the transformation process may omit parts of the source document.

The content transformation process includes device/browser-specific transformations so that the unsupported mark-up can be removed, replaced or otherwise altered as necessary. To do this, each supported device (or class of device) is assigned a collection of transformation rules that are added to the initial set of rules performed by the transformation engine. The rules are selected dynamically as appropriate to the characteristics to the delivery channel. A collection of such rules is referred to as the DTM. The rules within a DTM may be applied directly by the transformation process, and/or applied indirectly via additional software components referenced (or embedded) in the DTM. A DTM may be held in persistent storage for use by the server. The server may create a new DTM through the union of several DTMs as shown in FIG. 1.

iDOM

Every element in the source DOM has responsibility for its own transformation for the target user-agent, and these transformations can take place at different times and in different orders according to different circumstances. For example, an iDOM node may commence self-transformation while the rest of the iDOM is being constructed. The method does not necessarily perform transformation only after complete construction of the source DOM.

Another feature of the method is a set of “tag to TransformingElement implementation” mappings on a per-channel basis, which can be extended on a per device/device-family basis. The mappings are used by the iDOM when its nodes are performing transformations.

The Structure of a DTM

A DTM is a collection of rules that may be stored as an XML document, comprising zero or more native rules and zero or more external rules. The types of rules supported by DTMs are:

Native Rule. Rules that are recognised and executed directly by the DTM execution mechanism. A typical set of native rules would include the following:

Substitution rule. The observed pattern (such as a particular tag or particular attribute value or any other pattern associated with the markup) is replaced by alternative content.

Deletion rule. Elements (nodes) that depend on the current element are attached to the parent of the current element, and the current element is then removed from the iDOM.

Complete deletion rule. The current element, and any dependant elements, is removed from the iDOM.

Prepend rule. New content is inserted before the current element.

Append rule. New content is inserted after the current element.

Wrap rule. The current element is removed and attached to a new element. The new element takes the place of the removed element. The new element then becomes the current element.

Null rule. This indicates that the element and all its dependants are not to be processed. This would be used where it is known that the target device/browser will properly support the element as represented in the iDOM.

External or Embedded Rule. These rules refer to external (or embedded) software components that are to be instantiated and made responsible for processing the element indicated by the rule. The reference may be to an object class that provides a well-defined method interface through which the class may process the element. Alternatively, the reference may be to software embedded within the DTM itself.

Compound Rule. This is a list of native rules that are applied in the listed order.

Import Rule. An import rule contains a reference to another DTM, and the rules of the referenced DTM are to be included in the set of rules in the referencing DTM.

The external rule is the only necessary rule type because any native rule may be implemented as an external rule. Native rules are likely to be more efficient in an embodiment of this invention because they avoid the need to locate and/or instantiate external objects/methods. Common rules would normally be made available as native rules.

Every rule may be contained within a condition. A condition is a Boolean expression that may contain references to attributes obtained from the DTM execution process. If the condition is true, the rule is treated as if it were not contained in the condition. If the condition is false, the rule is treated as if it were not present in the DTM.

The collection of rules in a DTM may be ordered or unordered. In an ordered collection, the order represents the precedence of the rules so that applicable rules of higher precedence will be selected in preference to applicable rules of lower precedence. In an unordered collection, all rules have equal precedence.

Where an import rule R in DTM A refers to a DTM B, the precedence of each rule in DTM B shall not exceed the precedence of rule R. Furthermore, if DTM A is an ordered collection, then the precedence of each rule in DTM B shall exceed the precedence of any rule after R in DTM A.

Selection/Construction of a DTM

When the device/browser to which the content will be delivered is known, a collection of DTMs is selected and the union of the DTMs in the collection creates a new DTM that is made available to the transformation processes in the iDOM. Through union of DTMs, a DTM can be constructed for each supported delivery channel. Individual DTMs (such as those held in persistent storage) may be used in different DTM unions for different delivery channels. The server includes a selection process that uses device/browser attributes and other attributes associated with the delivery channel and/or user device attributes to determine the appropriate collection of DTMs. When creating a union of DTMs, rules that apply to the same case are resolved to a single rule by choosing the one from the set of rules having the highest precedence.

Execution of DTMs

During the transformation of the original iDOM to an iDOM that represents the delivered content, the iDOM uses transformation processes associated with the elements comprising the iDOM. Transformation processes may apply to individual elements and/or groups of elements within the iDOM. The transformation process involves the invocation of selected DTMs (i.e. those which are appropriate to the element(s) and the delivery channel). The transformation process takes place in a single pass, unlike many existing DOM transformation processes that require multiple passes (e.g. XSLT). At each step in the traversal, an applicable rule (if any) is identified in the selected/constructed DTM and applied to the iDOM.

In one embodiment, the delivery channel is determined by the characteristics of the user, device, browser and any other feature of the path from the server to the consumer that may influence the creation of content. Delivery channels may be grouped or classified. The delivery channel determines which object in a set of possible “agent” objects will be selected to perform transformation. These objects implement the methods of a TransformationAgent (an “interface”) and they drive the construction of the transformed iDOM from the original iDOM. There are TransformationAgent implementations for each delivery channel to be supported.

In one embodiment, it is the task of each TransformationAgent implementation to load the appropriate list of tag-to-element implementation mappings (Transformation Maps) for the given channel. These mappings are defined in the form of Dynamic Transformation Maps (DTMs), which are a set of XML modules.

In one embodiment, DTMs are represented as XML documents and associated external classes (together called a DTM module). A runtime Transformation Map is built by loading one or more DTM modules (a DTM module set). The functionality of the transformation process can be extended by using a DTM Application Program Interface (API) to change the DTMs for a specific device/browser or class of device/browser. New DTMs may be added via the DTM API. When a changed DTM, or a new DTM, indicates a new software component to execute a transformation, the new software component must be made available to the TransformationAgent implementations. Such software components are implementations of a “handler class” and must implement a common DTM interface to be compatible with the DTM framework.

In one embodiment, the DTM document data structure is defined in a separate Transformation Map Document Type Definition (DTD).

In one embodiment, each supported delivery channel is associated with an ordered DTM. Each DTM contains zero or more import rules that relate to specialisations in the channel, arranged so that import rules occur before other rules. For example, a channel may be an “XHTML Basic device to which has been added the XHTML Table module”. In this case, there would be an “XHTML Basic DTM”, which would contain a conditional import rule referring to the “XHTML Table Module DTM”. The condition would be true because the DTM execution mechanism indicates that the XHTML Table module is part of the delivery channel. Therefore the collection of rules to apply to the transformation would comprise all of the rules from both of the indicated DTMs. By giving import rules precedence over other rules in a DTM, this embodiment ensures that specialised rules override more general rules.

Samples of the DTM as a Document

In one embodiment, among the set of DTMs there exists a DTM for the Model R3xx mobile telephone. The Model R3xx mobile phone supports the <table> tag unlike several other WAP devices that do not, because the mark-up standard did not include tables for mobile phones. A new handler class (“ExtTableElement”) is introduced that will be instantiated by the server to transform tables for the R3xx. The DTM below specifies a handler class for the “table” element, and this DTM will be applied by the iDOM when the delivery channel involves the R3xx:

<?xml version=“1.0”?>
<!DOCTYPE everix-transformation-map SYSTEM “transformation-
map.dtd”>
<everix-transformation-map>
<import-map name=“wml/1.1/map/xhtml/mm-xhtml/1.0/map”/>
<element name=“table”>
<settings>
<setting name=“class”
value=“com.mobileaware.DTM.elements.WML.tables.ExtTableElement”
/>
<setting name=“is-separable” value=“false” />
<setting name=“nested-table-transform” value=”on-new-card” />
<attributes>
<attribute name=“id” />
<attribute name=“class” />
<attribute name=“title” />
<attribute name=“align” />
<attribute name=“columns” />
</attributes>
</settings>
</element>
</everix-transformation-map>

Below is another example derived from an embodiment of DTMs. Within the sample is an example of a substitution rule, in the form of an <action>. The action indicates that an “<xyz>” element is to be replaced by an “<i>” element, and that the “id” and “font” attributes are to be retained, and that the value of the “id” attribute should be the name of the element. (The syntax uses the $ prefix to indicate environmental variables.)

```
<?xml version=“1.0”?>
<!DOCTYPE everix-transformation-map SYSTEM “transformation-
map.dtd”>
<everix-transformation-map>
<!-- Module import definition -->
<import-map name=“MyDTMModule”/>
<!-- Element definition -->
<element name=“xyz”>
<action type=“replace” element=“i”>
    <attributes>
        <attribute name=“id” value=“$id” default=“$name” />
        <attribute name=“font” value=“$font” />
    </attributes>
</action>
</element>
</everix-transformation-map>
```

In the following example from an embodiment of DTMs, external rules are introduced that replace elements in the iDOM with content that represents a fragment of embedded script, thus permitting input documents to refer to client-side processes by way of mark-up tags. Here, a <banner> tag is replaced by JavaScript to display a banner, and a <navmenu> tag is replaced by a JavaScript navigation menu script.

<?xml version=“1.0”?>
<!DOCTYPE everix-transformation-map SYSTEM “transforxmation-
map.dtd”>
<everix-transformation-map>
<element name=“banner”>
<settings>
<setting name=“class”
value=“com.mobileaware.ICA.HTML.BannerElement” />
</settings>
</element>
<element name=“navmenu”>
<settings>
<setting name=“class”
value=“com.mobileaware.ICA.HTML.NavmenuElement”
/>
</settings>
</element>
</everix-transformation-map>

The following fragment of Java™ program illustrates how the BannerElement class (referred to in the previous example) may be implemented:

public class BannerElement extends TransformingElement {
// This handles markup like this:
// <banner id=“mybanner” type=“dynamic” controlWidth=“30” >A
banner
message.</banner>
public BannerElement(String name) {
super(name);
}
public BannerElement(String name, Namespace nameSpace) {
super(name, nameSpace);
}
protected void elementAdded( ) {
RegularElement elementBefore = getElementBefore( );
super.elementAdded( );
if (elementBefore != null) {
getElementBefore( ).cleanForward( );
}
}
public void processEndElement(int userAgent) throws
MMParseException {
switch(userAgent) {
case TransformationAgent.USERAGENT_HTML: {
String bannerMsg = getText( );
String bannerType = getAttributeValue(“type”);
String bannerId = getAttributeValue(“id”);
String bannerWidth = getAttributeValue(“controlWidth”);
if(bannerType != null && bannerType.equalsIgnorecase(“dynamic”)) {
StringBuffer cmdBuf = new StringBuffer(“banner(\“”)
.append(bannerId) .append(“\”,\“”) .append(bannerMsg)
.append(“\”, \“”) .append(bannerWidth) .append(“\”);”);
RegularElement replacement1 = getTA( ).getInstance(“script”);
insertBefore(replacement1);
replacement1.addAttribute(“language”, “JavaScript”);
replacement1.addAttribute(“src”, “js/banner.js”);
replacement1.addContent(“ ”);
RegularElement replacement2 = getTA( ).getInstance(“script”);
insertBefore(replacement2);
replacement2.addAttribute(“language”, “JavaScript”);
replacement2.addContent(cmdBuf.toString( ));
}
else {
RegularElement replacement1 = getTA( ).getInstance(“center”);
insertBefore(replacement1);
replacement1.addContent(bannerMsg);
}
removeFromParent( );
break;
}
default: {
moveChildrenToGrandparent( );
break;
}
}
setTransformed(true);
}
public void transformElement(int userAgent) {
setTransformed(true);
}
}

The invention is not limited to the embodiments described, but may be varied in construction and detail. For example, the server hardware architecture may allow parallel processing with simultaneous node transformations. In this embodiment, the nodes are preferably in separate hierarchical branches of the source DOM.

1. A process carried out by a server for providing an output document of content for delivery to a user device, by transforming a source document, characterised in that,
the source document is represented in the server as a source document object model (DOM) having a plurality of interconnected nodes,
the server dynamically selects a transformation map according to characteristics of the user device and/or its delivery channel, the transformation map comprising at least one transformation rule, and
the server transforms the source DOM to a target DOM on a node-by-node basis according to the selected transformation map.

2. A process as claimed in claim 1, wherein a source node transforms to provide a target node having different attributes.

3. A process as claimed in claims 1, wherein a source node transforms to provide a target node having a different node-to-node relationships.

4. A process as claimed in claim 1, wherein a source node transforms to provide different attributes or relationships of a plurality of target nodes.

5. A process as claimed in claim 1, wherein a source node transforms to create at least one additional target node.

6. A process as claimed in claim 1, wherein at least one source node self-transforms by executing a node method to dynamically execute a rule of the transformation map.

7. A process as claimed in claim 1, wherein there is a transformation map associated with each potential user device and delivery channel combination.

8. A process as claimed in claim 1, wherein a rule of the selected transformation map causes an additional rule to be retrieved, either from within the server or from an external system.

9. A process as claimed in claim 5, wherein a node transforms while other source document nodes are being linked to complete the source DOM.

10. A process as claimed in claim 1, wherein the transformation takes place in a single pass.

11. A process as claimed in claim 1, wherein the transformation map is represented as a mark-up language document and associated external classes.

12. A process as claimed in claim 1, comprising the step of selecting a plurality of transformation maps and merging them to provide a compound transformation map.

13. A process as claimed in claim 1, wherein the transformation map includes a null rule causing a source node to be unchanged.

14. A process as claimed in claim 1, wherein external rules referenced by rules of the transformation map are retrieved by reference to an object class.

15. A process as claimed in claim 1, wherein the transformation replaces elements in a source node with content that represents a fragment of embedded script in which a tag refers to a user device-side process.

16. A server comprising means for performing a process of claim 1.

17. A computer program product comprising software code for performing a method of claim 1 when executing on a digital computer.
